(19) United States
(12) Patent Application Publication
(10) Pub. No.: US 2006/0288010 A1
(43) Pub. Date: Dec. 21, 2006

(54) Networking at a convention

(76) Inventors: Jeffrey Chen, Irvine, CA (US); Linus Liang, Irvine, CA (US)

Correspondence Address: PERKINS COIE LLP, P.O. BOX 2168, MENLO PARK, CA, 94026, US

(21) Appl. No.: 11/439,388

(22) Filed: May 22, 2006

Related U.S. Application Data
(60) Provisional application No. 60/682,631, filed on May 20, 2005.

(51) Int. Cl. G06F 17/30

(52) U.S. Cl. 707/9

(57) ABSTRACT

In various embodiments, a system, method and apparatus for networking at a convention is provided. In one embodiment, a method is presented. The method includes receiving a login identification from a user over the Internet. The method further includes encrypting a portion of the login identification from the user. The method also includes querying a database as to whether the login identification with the encrypted portion of the login identification matches an entry in the database. The database is related to a convention which the user is attending. The method further includes granting the user access to the database. In another embodiment, a system is presented. The system includes a personal digital assistant (PDA). The PDA has a network interface. The PDA has a user interface. The PDA is to receive login information from a user. The PDA is also to transmit the login information over the Internet to a server. The PDA is further to receive convention information from the server over the Internet consistent with access permissions of the user.

### CROSS-REFERENCE TO RELATED APPLICATION

This application claims priority to U.S. Provisional Patent Application No. 60/682,631, filed on May 20, 2005, and which is hereby incorporated herein by reference.

### BACKGROUND

Conventions and similar events involve convergence of hundreds or thousands of attendees, potentially from all over the world. This represents a fantastic opportunity to meet people in a profession, expand personal and professional networks, and renew or strengthen existing contacts. However, conventions are also typically a sea of people, making the process of locating a particular individual and achieving contact a potentially difficult process. Such technologies as the physical bulletin board and a paper copy of attendees have been used over the years, with limited success. An attendee may or may not see the bulletin board, and contact information for attendees may not be useful while at the conference. Thus, it may be useful to provide a system which facilitates such contact.

Similarly, determining what events at a convention are available for sign-up—whether updated, cancelled or added, may be useful to attendees. For example, a change in room or time of an event can be vital for those wishing to attend. Similarly, an added meeting for a hot topic can be useful—if people know about it. Thus, providing a system which enables distribution of schedule information may be helpful.

Although the introduction of wireless networks in a convention setting is relatively new, several competitors have already begun to test their products in the market. In the United States, AllianceTech and WingateWeb have such products, and in Europe, SpotMe has such a product. Other systems have been designed to solve the problem as described above. One system issues paper tickets for each attraction. This system requires the patron to walk to the desired event or attraction prior to the actual scheduled time in order to acquire the ticket. This system is not real-time for the patron and does not give any information on the real-time status of events and attractions.

Another system involves a wireless system to schedule appointments. However, this system utilizes cumbersome computers at each attraction, thereby increasing cost and decreasing the performance efficiency. Requiring use of dedicated terminals can be difficult for convention users who may have their own devices with them.

In yet another system, tickets are issued to portable terminal devices in place of actual tickets. This system is therefore another method of issuing tickets. In still another system, users are scheduled to an amusement park through the use of two different communication networks. This system uses communication through each user terminal which is separate from the communications between the central server and each facility.

In another system, cellular phones and keying from cellular phones is used to manage patrons. This system involves two bases for entry: the first-in-first-out basis, and the priority basis established by a prior allocation of a space to the attraction. In addition, this system limits the scope of the system to only cellular phones.

In another system, reservation of times using the internet occurs. However, this system is limited to the use of the internet as a means to communicate between the devices and the server. This system does not allow for communication through other (e.g. local) networks.

### BRIEF DESCRIPTION OF THE DRAWINGS

The present invention is illustrated by way of example in the accompanying drawings. The drawings should be understood as illustrative rather than limiting.

FIG. 1A illustrates an example map in one embodiment.

FIG. 1B illustrates an example of a schedule view in one embodiment.

FIG. 2 illustrates an example of a search interface in one embodiment.

FIG. 3 illustrates an embodiment of an attendee list.

FIG. 4 illustrates a system architecture in one embodiment.

FIG. 5 illustrates an embodiment of the system with a view of its security layout.

FIG. 6 illustrates an embodiment of user authentication.

FIG. 7 illustrates an embodiment of a network which may be usable with the system in some embodiments.

FIG. 8 illustrates an embodiment of a computer or personal device usable in the system in some embodiments.

FIG. 9 illustrates transactions and interaction which may occur for a system administrator within the system in one embodiment.

FIG. 10 illustrates transactions and interaction which may occur for an event manager within the system in one embodiment.

FIG. 11 illustrates transactions and interaction which may occur for a vendor within the system in one embodiment.

FIG. 12 illustrates transactions and interaction which may occur for a patron or attendee within the system in one embodiment.

### DETAILED DESCRIPTION

A system, method and apparatus is provided for networking at a convention. The specific embodiments described in this document represent exemplary instances of the present invention, and are illustrative in nature rather than restrictive.

In one embodiment, the system provides real-time event information, customized advertising, and optimized lead generation in high traffic venues over wireless networks using personal digital assistants and laptops. The system may be used by vendors and event managers at high traffic venues, who need to increase revenue, save costs, and increase efficiency during high traffic events. The system may include hardware, software, and services that provide advertising, scheduling, data-mining, and real-time updates. Unlike current paper-based systems of guides, schedules, and advertising, such a system can dynamically schedule, advertise, assist as a social networking device, and update using laptops and personal digital assistants.

In an embodiment, the system is easily accessible using patron's personal digital assistants (PDAs), cell phones and laptops via connecting to a central webserver through a WiFi network to retrieve real-time venue information and advertising. Patrons of busy venues will use a mobile device to access the central server through software to schedule appointments with other product users and sign up for the venue's events. The software program dynamically allocates appointments based on customers' requests. This may also include other features for the user, including real-time updates, self-checkout, instant messaging and the ability to store brochures and contact information.

Such a system may address the problem of inefficient time management during attendance of high-volume venues. This system thus attempts to target the common pains experienced at major conventions and trade shows. Thus, this product may be used by the convention coordinators, vendors, and convention attendees to help disseminate information as well as improve networking among these participants. Furthermore, such a system may be used in other types of venues including casinos, cruise ships, amusement parks and museums.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

In an embodiment, a method is presented. The method includes receiving a login identification from a user over the Internet. The method further includes encrypting a portion of the login identification from the user. The method also includes querying a database as to whether the login identification with the encrypted portion of the login identification matches an entry in the database. The database is related to a convention which the user is attending. The method further includes granting the user access to the database.

In another embodiment, a system is presented. The system includes a personal digital assistant (PDA). The PDA has a network interface. The PDA has a user interface. The PDA is to receive login information from a user. The PDA is also to transmit the login information over the Internet to a server. The PDA is further to receive convention information from the server over the Internet consistent with access permissions of the user.

In yet another embodiment, a system is presented. The system includes a server computer. The server computer includes a network interface. The network interface is coupled to the Internet. The server computer includes a database interface. The database interface is to couple to a database having information related to a convention. The server computer has a first access path through the network interface for read and write access by privileged users through the server computer to the database and information related to the convention. The server computer also has a second access path through the network interface for read-only access by non-privileged users through the server computer to the database and information related to the convention.

Below is a description of various aspects of one embodiment. This has been broken down by listing the functionality for each of 5 different user groups. Even though there will be some redundancy, e.g. each user group will have logon functionalities, such redundancies are still included in the feature list. The different user groups are categorized in this embodiment as the: System Administrator, Event-Manager, Vendor, End-User (1), and End-User (2).

System Administrator—Such a user will typically have full control of every aspect of the system. This potentially includes access to all hardware, software, and data components.

For a system administrator, access to underlying databases is important, and this potentially includes encryption and decryption capabilities, so a database interface and encryption engine may be included. Additionally, the system administrator will have access to a web server and related services of the system. This may include a development server (used for development of the system), and a production server (used for the system in commercial use). This may also include access to web services to select which services are to be used in a given event. Similarly, login/logout functionality is provided to a system administrator.

Once logged in, the system administrator may execute a number of actions. Conferences may be set up, viewed, edited and deleted. Events and meetings may similarly be scheduled, including set-up, view, edit and delete options. This may further involve manually rearranging a user's schedule in some instances.

Requirements and preferences of events and users may also be adjusted. Thus, events may be adjusted by the system administrator to alter name, time, location, attendance list, etc. Similarly, user information may be adjusted—changing password, account information, personal information, even allowing the system administrator to effectively become a user within the system. Broadcast information may also be affected by the system administrator. Thus, advertising may be selected, added, viewed, edited, deleted, or broadcast properties may be set. Similarly, announcements may be created, broadcast, or altered, for example.

The system administrator may also adjust specific information about the conference. For example, attendance information may be adjusted. Thus, a list of attendees may be accessed and access control for that list may occur—e.g. other user's access to the list of attendees may be controlled. Moreover, subsets of the attendee list may be created, with various users assigned to such a list and various users given access to the list. Similarly, conference requirements can be set or modified. Thus, events may be added and altered. Similarly, a conference map may be created, loaded, and edited as appropriate to reflect the physical layout of a conference and changes thereto. Moreover, rooms may be selected and altered for meetings or events.

Event-manager—An event manager will be able to manipulate the different aspects of the conference. Thus, an event manager will also have login/logout features. The event manager also may access and alter event requirements, such as name, time, location, attendees, for example. Similarly, the event manager may add, delete and view user information and user account information for an event. Moreover, the event manager may add, delete or change attributes of an advertisement or announcement, for example. Also, the event manager may control attendance lists for events, meetings and the like, such as viewing attendees, controlling who can view attendees, and creating subsets of attendee lists for various purposes.

Vendor—A vendor will typically be able to manipulate only the events and advertisements they own. As expected, a vendor may login and logout. Additionally, a vendor may add, delete or change their own user account information, and control to some degree who can see such information.

A vendor may schedule networking opportunities such as meetings with other users, creating, editing and deleting meetings, and requesting, accepting or rejecting meetings. Likewise, a vendor can manage a personal contact list, and may access an attendees list if authorization is granted. Moreover, a vendor may access general conference information such as maps, lists of events and booths, directions, and the like.

Similarly, the vendor may access information about their own events, adding information, viewing, deleting and modifying existing information about an event such as name, time, attendees, etc. Additionally, a vendor may access and change advertisements from the vendor, adding, editing and deleting advertisements as appropriate.

End-User (Professional Attendees)—This user group represents conference attendees who are industry affiliated but do not have their own booths. Such attendees may be some form of sponsors, or otherwise affiliated with the group planning the event, for example.

As with other users, such users may login and logout of the network. Similarly, such users may add, delete and edit their own account information and control who else may access such information. Also, such users may schedule personal meetings, add personal contacts, and view the overall attendees list as authorized. Likewise, such users may view general conference information such as maps, lists of booths and events, directions, etc. Moreover, such users may set advertising preferences and may view advertisements.

End-User (General Public)—This user group represents the general public who might be attending the conference. Such users may login and logout. Also, such users may add, delete and edit their own account information and control who else may access such information. Also, such users may schedule personal meetings, add personal contacts, and view the overall attendees list as authorized. Likewise, such users may view general conference information such as maps, lists of booths and events, directions, etc. Moreover, such users may set advertising preferences and may view advertisements.

This section describes a user interface in one embodiment, with a description of various different features which may be incorporated in other embodiments. These features are not necessarily interdependent—various embodiments need not include all of these features and aspects of the user interface.

First, access by an administrative user is described and illustrated. The administrative user (admin) logs in by entering a user name and a password or similar identification information. The admin may either select a conference or create a new conference and fill out information about it such as name, date, and location. Once the admin selects a conference they will be presented with the information about it. Thus, they can proceed to edit and change erroneous information.

The setup software may ask for a jpg (or similar format) map that can be selected from somewhere on the user's hard drive, for example. For every room on the map, a clickable region may be specified for end users. The admin will click an ‘add room’ button, and be prompted for the name of the new room, for example. The admin will then be prompted to click on the map to specify a series of points that make up the vertices on the clickable region. Then the admin can right click or click the ‘done’ button to specify that he is done adding points.

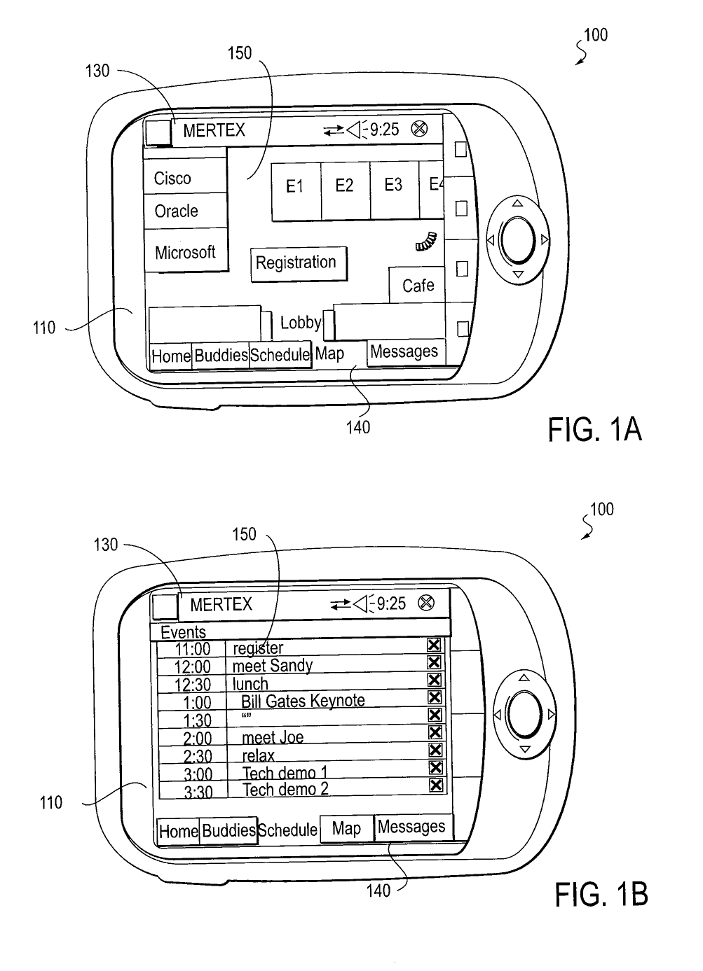

An example map is illustrated in FIG. 1A. Device 100 displays a map 110 on a screen, which includes a map image 120 (with the aforementioned clickable regions), a menu bar 130 and navigation tabs 140. The navigation tabs 140 may be used to bring the map view up on the screen, or to bring up a schedule view, messages view, buddies view, or home view. The messages view may provide messages from other users, the buddies view may provide buddy information for instant messaging or peer-to-peer buddies, and the home view may provide introductory information for the conference. As illustrated, the map 110 includes a set of clickable regions denoted by boxes (roughly) on the image 120.

For admin access, an ‘add event’ button or similar control may be provided to allow the admin to add an additional event. When the admin clicks this button he will be prompted for: room, start time, end time, and owners for example. Then he can add another event. In some embodiments, the events will be automatically entered from an existing database of events.

Similarly, the admin may add a patron through an ‘add patron’ button or similar control. When the admin clicks the button he will be prompted to enter all the information about a patron: name, title, industry, company, for example. He can also check a box to have the patron invisible to all other patrons, and check another box to grant this patron access to the attendee list. In some embodiments, the patrons will be automatically entered from an existing database of patrons, or as they register for the convention in the first place. The patrons may be simple attendees of the event, for example.

For advertising, the admin may add an advertisement with an ‘add advertisement’ button or similar control. It will prompt the administrator to choose a jpg image (or other format) of a specific size from an accessible storage location. Restrictions on the advertisement may be entered, such as an industry, timing, frequency, or other restrictions on display.

For other users, set up may be different. For example, another user will not be in a position to modify an event map. Event managers may have this option, but typically no other user would have such an option. The following description assumes the user does not have administrative rights, privileges or responsibilities.

A user may log in by entering a user name and a password or similarly identifying him or herself. This may be required only once per convention, or may be dependent on continuous access to a network. When the user selects the map screen it will mark with an ‘X’ the place he is supposed to be at the current time, for example.

He can then scroll on the map by dragging, or zoom in/out by clicking the ‘zoom in’ and ‘zoom out’ buttons. The rooms will be labeled on the map as per the image set up by the administrator. When the user clicks on a room, details about the event currently happening in that room may be displayed. In an embodiment, this event information will cover half of the screen so that half of the screen is still available for the map. The map may also provide an indication of where the user actually is when locating technology is available, such as a GPS-enabled device and corresponding map, or through use of a kiosk which has a predetermined location.

When the user selects the schedule screen the schedule will be shown in chronological order in a fashion similar to any calendar application in an embodiment. When an event is clicked on information about the event will cover half the screen, for example. One piece of included information may be the room for the event. If the user clicks on the room info, the half of the screen with the event information will be replaced with the map and the room in question will be marked with a red X. Other implementation may also be used in other embodiments, preferably to provide similar information.

FIG. 1B illustrates an example of a schedule view. Display 100 provides an image 110. In this instance, the image 110 includes schedule 150, along with menu bar 130 and navigation tabs 140. Schedule 150, as illustrated, shows times and events, either meetings specific to the user or convention events, for example. Schedule 150 may also illustrate potential events, allowing the user to select from a variety of events and have the system prepare a customized meeting schedule.

In one embodiment, the user searches through the events and for each one rate how badly he wants to attend, as well as specifying how long he wants to stay there (for talks, this will be the entire time in most cases). Then he will be presented with a list of possible schedules. If he clicks on a schedule he will be shown a schedule view, as described above. There will be a ‘finalize’ button or similar control that confirms that this is the schedule he plans to follow in one embodiment. In the schedule view, when the user is viewing event information there will be a ‘cancel event’ button or similar control. This will remove the event from his schedule and bring up a list of possible events to fill its place. Alternately, there may be a ‘modify event’ button or similar control, allowing the user to modify parameters such as times for a private meeting.

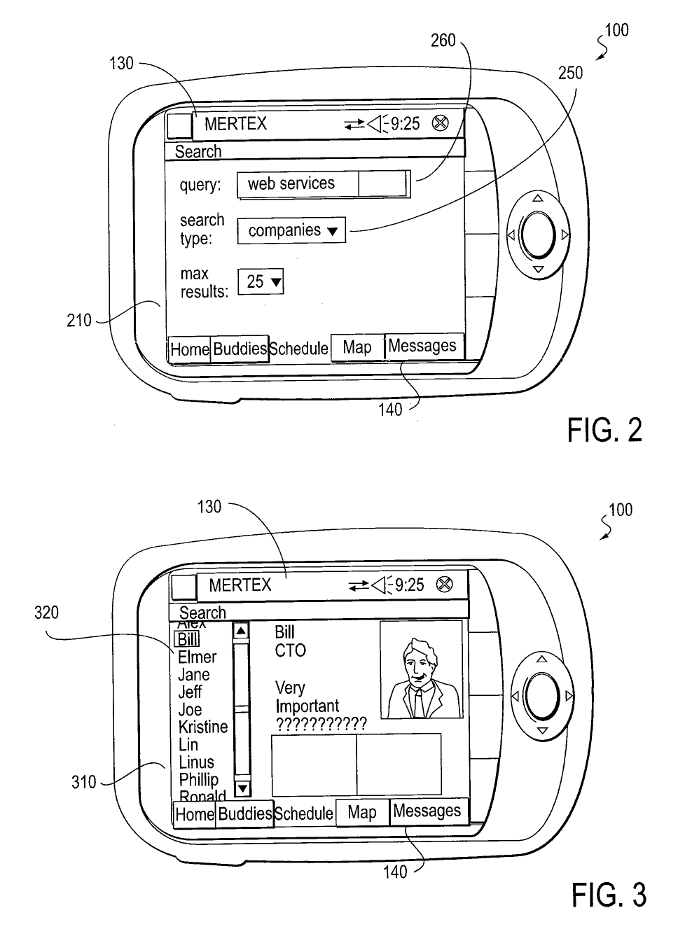

Additionally, the user can search for events by specifying any combination of: time, place, or people involved in some embodiments. Alternatively, the user can search for people by specifying any combination of: name, company, title, for example. FIG. 2 illustrates an example of a search interface in one embodiment. Display 100 provides a display image 210. This includes a menu bar 130 and a set of navigation tabs 140. It also includes a search interface, in this embodiment including a search query 220, search type 230 (e.g. how to restrict the search) and results parameter 240 (e.g. maximum number of results or results per screen, for example). This interface allows for search of a user's schedule or a conference schedule. Alternatively, the interface may also allow for search of patrons or attendees.

There are many types of events that can be created. For example, a technical session and a vendor booth can be created in this set. The user will be able to set the preferences and edit the information about these types of events. Then, a user will be able to see a list of events which fit a certain criteria. All the information about the event that the user has permissions to see will be displayed. Moreover, the user will be able to set their preferences and edit their information. For example, the user may select the industry that he is interested in.

Similarly, the user can view the list of people currently on his contact list. By clicking on a name he can view that person's profile. The user may use a ‘send profile’ button or similar control which sends that user a message offering to be added to that person's contact list, for example. The user may also use a ‘remove contact’ button or similar control to remove a person from the list.

Likewise, names may be listed alphabetically on the attendee list screen for the user. When the user clicks on one he will see their profile, and there will be an ‘add to contact list’ option or similar control available. Not all users will have every other user in their attendee list—subsets of the attendee list or similar restrictions may be implemented. The admin or potentially the event manager can set this up, for example.

FIG. 3 illustrates an embodiment of an attendee list. Display 100 includes display image 110. Display image 110, in turn, includes menu bar 130 and navigation tabs 140, along with attendee list 320, attendee information 330 and controls 340. Controls 340 may allow for specific actions related to an attendee shown in attendee information 330, such as requesting or scheduling a meeting, or adding the attendee to a contact list. Attendee list 320 may be scrolled through to find information on other attendees, with each appearing with attendee information 330 in turn.

In some embodiments, a small advertisement on the side on every screen is provided. Which advertisement is displayed is dictated by the admin when he does advertisement setup—although this may be in the nature of setting parameters and allowing the system to select advertisements in conformity with such parameters. Such advertising may be a source of revenue for the convention and/or the operators of the system, or may be part of sponsorship opportunities for the convention, for example.

In an embodiment, the system has three distinct layers in the architecture: clients, servers, and a database. Communication between the client and server would be conducted with SSL encryption in some embodiments. The public key (key1) may be hard-coded into the client to avoid server masquerading issues when a malicious user imitates the server and asks the user to login with a false encryption key, for example. All calls made to the system from different clients to the server will be encrypted using SSL in such an embodiment. These calls include requests for vendors, patrons, and other calls by the user.

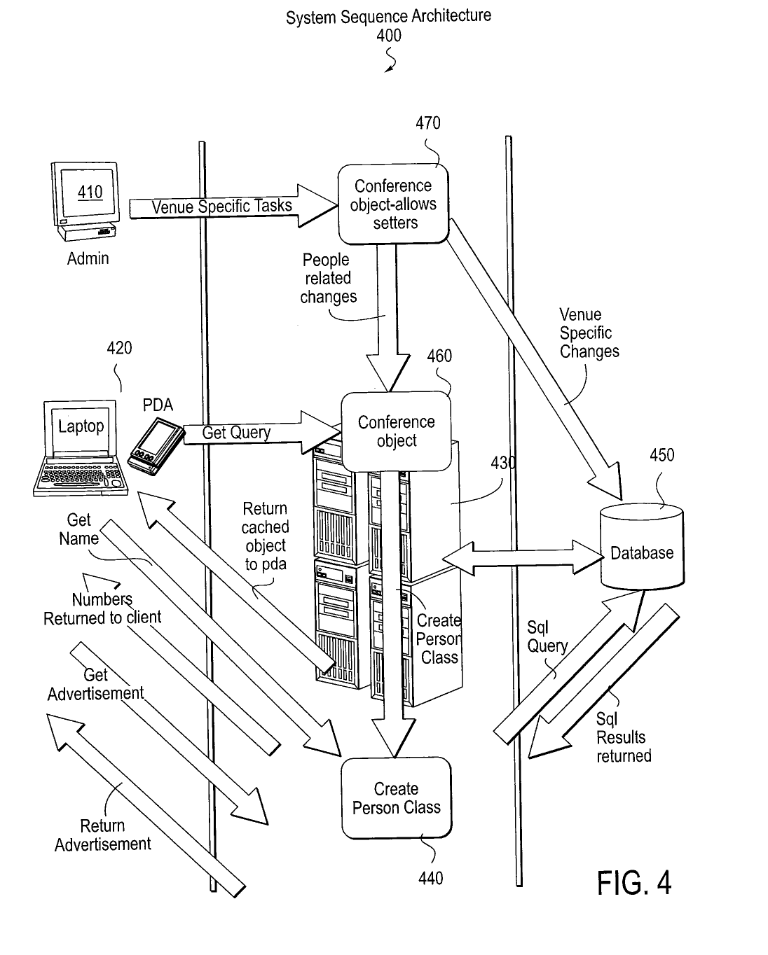

FIG. 4 illustrates a system architecture in one embodiment. System 400 includes a server (or servers), clients, administrative access terminal, database, and related data objects. Administrative terminal 410 allows for administrative user access to the conference object 470. This is implemented through servers 430 and the object 470 is actually stored at database 450. Object 470 allows for modifications of the conference—adding meetings, editing information, etc.

Clients 480 can access conference object 460. Object 460 is of a class related to object 470—it provides information about the conference, but does not allow for global editing. Access to conference object 460 is also through servers 430. Clients 480 may also access person objects 440 (similarly through servers 430). Person class and person objects 440 are modifiable by those with rights to modify, such as an owner of a specific instance (for that user, for example), or for individuals with group access rights (such as event managers, for example). Each of objects 440, 460 and 470 are stored in database 450. Various types of transaction are illustrated between the various types of objects and clients (and the database), providing a further indication of the type of transactions one may engage in with each object. Moreover, as illustrated, either the world wide web or a local network is used to provide for transmission between the clients and the objects. However, the above-described implementation is only an example—other implementations may be used in various embodiments.

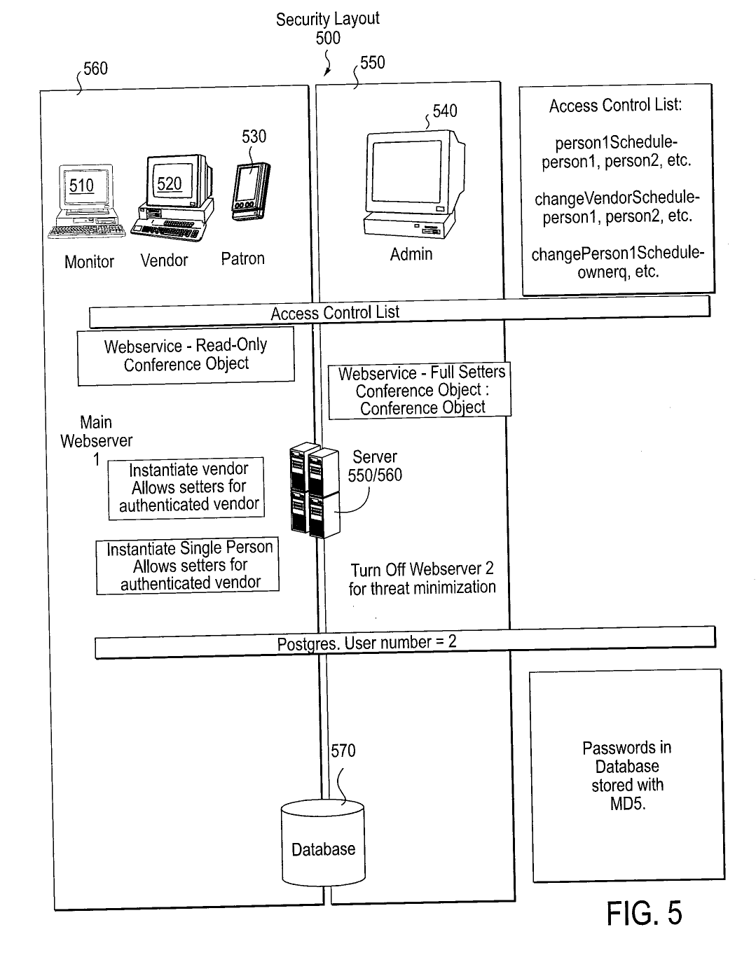

Although the system uses SSL encryption between the clients and the server, one may need to guard against a malicious attack from a client, keeping the system secure. The contents within SSL connections may thus be secured to ensure that no malicious attacks can be conducted by the clients on the webserver and the database. FIG. 5 illustrates an embodiment of the system with a view of its security layout. System 500 includes clients, a server, a database, and an administrative client.

Servers (550 or 550 and 560 in some embodiments) can access database 570, through a secure access link. Administrative access path 590 provides for administrative access to the system, through client 540. Client 540 thus has a path to server 560 which may be used for sensitive access to the system—e.g. changing event information or user information administratively. However, path 590 may be shutdown in case of a threat, and is kept separate from other access paths. Webserver 560 may represent a restricted webserver accessible only by the system administrator, and may be a second webserver or webserver 2 in some embodiments.

Public access path 580 is the access path for non-administrative users. Thus, a kiosk or monitor station 510, a vendor client 520 or a patron (attendee) client 530 may access server 550 through path 580. Path 580 allows for limited access, based on how the user is identified, to change information for that user, or what that user has access to (e.g. vendors and their advertising). Path 580 may be shutdown separately from path 590 if necessary to allow for access by some users in the event of an attack, for example. Webserver 550 may represent a webserver with essentially open access to all users (within the confines of the conference, for example), and may be a first webserver or webserver I in some embodiments. Thus, path 580 and webserver 550 may provide the open portion of the system, while path 590 and webserver 560 may provide the restricted access portion of the system.

Note that the system described above may be implemented in a variety of ways, particularly with respect to the servers. For example, a single server may be used to provide access for both the access path 580 and the access path 590—the different access paths may be implemented through different ports, for example. Thus, a single physical server may implemented two logical servers along different access paths, or a single logical server serving both access paths. Alternatively, additional physical servers may be added for each logical server—with multiple physical servers handling each access path, for example.

Further description of the system may provide additional insight into its function in this embodiment. Patrons, vendors and monitors will typically be accessing the server to view most contents of the conference, including: other patrons, other patrons contact information, other patron's schedules, conference sessions, advertisements, and vendors.

Patrons, vendors, and monitors will have access to the default read-only conference object inside the webserver. The conference object will allow them to access all of the necessary information that the conference has to offer. However, this conference object does not have setters and thus nothing can be changed through it.

A patron or attendee is typically given rights to his own person object. The instantiation of a new person object for each person gives him rights to change his own schedule. Authentication of person is done by password authentication method as described below. An access control list (ACL) is assigned to the patron, described below, and the patron is now able to change his own schedule, contact information, and preferences.

A vendor is typically given rights to his own exhibit. The instantiation of a new vendor object for each vendor gives him the ability to change and upload information of his exhibit. An ACL is also assigned to the vendor and it is described below.

System administrators are able to not only edit person data, but can also edit information about the venue. This interface uses webserver 2, which has all the features of the patrons and vendors in addition to the system administrator's ability to edit venue information. This may be implemented using a flag that disables all of the admin's abilities in one embodiment. By turning off the flag and compiling the code, the system may create the other webserver, this webserver will contain all the necessary checks to for ACLs to grant access. Webserver 2 is turned off or put on a local LAN network to preserve system integrity.

The database is where information is stored, and what should be protected from attacks. From a reading perspective, ACLs will typically prevent malicious users from attempting to compromise the system. All passwords are salted and encrypted before they are stored in the database in an embodiment. Other encryption methods may be used in various embodiments. Furthermore, protection of the database extends to only give access permissions to the webserver so that attackers will not gain access to the database by direct connection.

Active control levels describe the activity that the server will allow for each type of user. For the most part, all users will be able to read information (except passwords and private information) from the database. The system administrator will typically be the only person that will be able to have full read and write abilities for the entire conference. The following table describes the ACLs for an hypothetical object:

| Item | Persons allowed for access |
|---|---|
| ViewPatronSchedule | Person1, person2, person3, etc |
| ChangePatronSchedule | Owner1 |
| ChangeVendorInformation | Person1, person2, person3, etc |

Passwords within the database typically would be encrypted since one does not want to put actual passwords into memory and page files during operation. In addition, one does not want to reveal all the actual passwords inside the database in the event of a successful attack. One embodiment uses the MD5 encryption scheme, which uses a large number to salt the data, before using RSA encryption and sending the data to the server. At login, the user provides the usemame, and password.

The password is then encrypted via MD5 and the packet sent to the server. The server checks to see if the encrypted password, username, and ACL exists in the database. If the record matches, then a person object will be instantiated and the user can proceed to modify his information on the server.

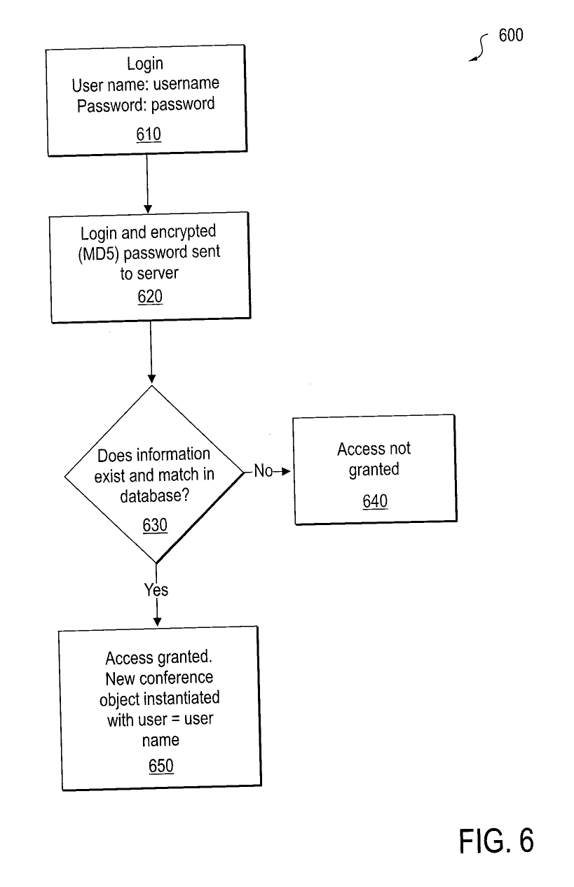

The access control list and related authentication may be further understood with reference to FIG. 6. Process 600 includes logging in, encrypting the password, checking the password against the database, and either granting or denying access. Method 600 and other methods of this document are composed of modules which may be rearranged into parallel or serial configurations, and may be subdivided or combined. The method may include additional or different modules, and the modules may be reorganized to achieve the same result, too.

Process 600 begins with a user login request at module 610. The username and password for the user are entered in one embodiment. At module 620, the login and encrypted password are sent to the server. At module 630, the login and encrypted password are submitted to the database for comparison with database records. If no matching record is found, at module 640 access is denied. If a matching record is found, access is granted at module 650 and the user is effectively logged in.

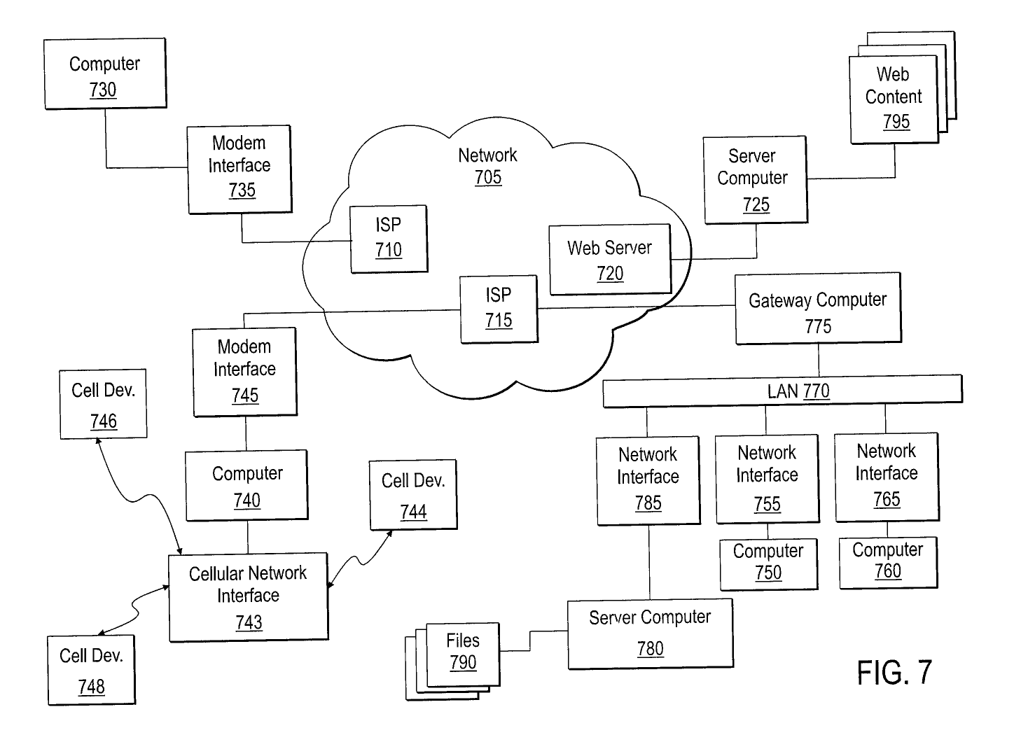

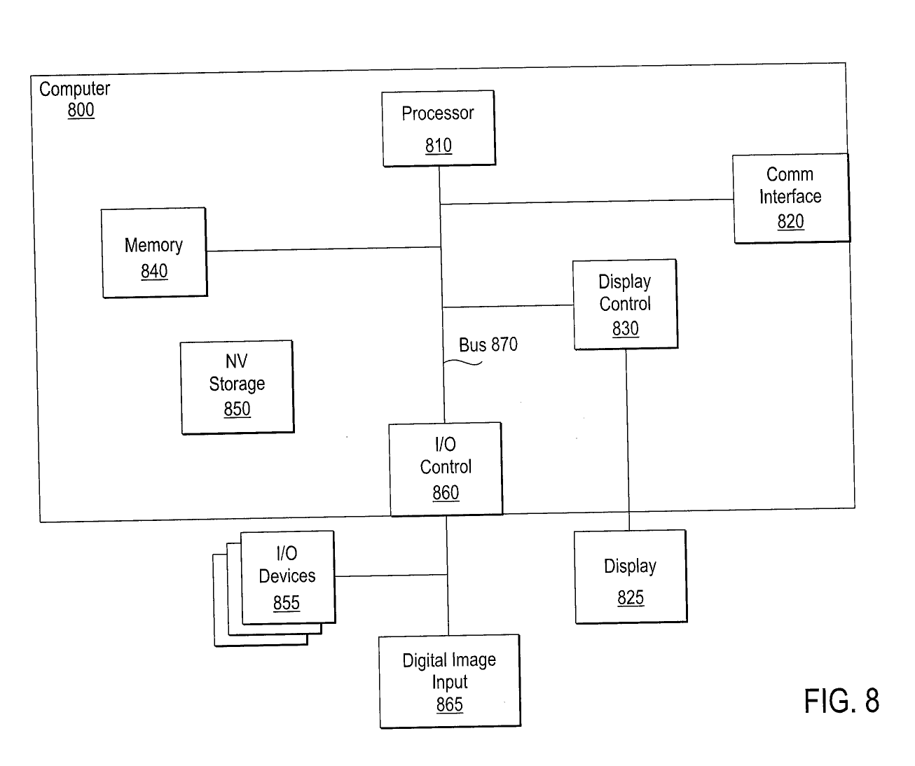

The following description of FIGS. 7-8 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet, along with a cellular network and related cellular devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Cellular network interface 743 provides an interface between a cellular network and corresponding cellular devices 744, 746 and 748 on one side, and network 705 on the other side. Thus cellular devices 744, 746 and 748, which may be personal devices including cellular telephones, two-way pagers, personal digital assistants or other similar devices, may connect with network 705 and exchange information such as email, content, or HTTP-formatted data, for example. Cellular network interface 743 is coupled to computer 740, which communicates with network 705 through modem interface 745. Computer 740 may be a personal computer, server computer or the like, and serves as a gateway. Thus, computer 740 may be similar to client computers 750 and 760 or to gateway computer 775, for example. Software or content may then be uploaded or downloaded through the connection provided by interface 743, computer 740 and modem 745.

Client computer systems 730, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 750 and 760, although as shown in FIG. 7, the connections are not the same as for more directly connected computer systems. Client computer systems 750 and 760 are part of a LAN coupled through a gateway computer 775. While FIG. 7 shows the interfaces 735 and 745 as generically as a “modem,” each of these interfaces can be an analog modem, isdn modem, cable modem, satellite transmission interface (e.g. “direct PC”), wireless access point, or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a personal device that can be used as a cellular telephone (744, 746 or 748) or similar personal device, or may be used as a more conventional personal computer, or as a PDA, for example. Such a device can be used to perform many functions depending on implementation, such as telephone communications, two-way pager communications, personal organizing, or similar functions. The system 800 of FIG. 8 may also be used to implement other devices such as a personal computer, network computer, or other similar systems. The computer system 800 interfaces to external systems through the communications interface 820. In a cellular telephone, this interface is typically a radio interface for communication with a cellular network, and may also include some form of cabled interface for use with an immediately available personal computer. In a two-way pager, the communications interface 820 is typically a radio interface for communication with a data transmission network, but may similarly include a cabled or cradled interface as well. In a personal digital assistant, communications interface 820 typically includes a cradled or cabled interface, and may also include some form of radio interface such as a Bluetooth or 802.11 interface, or a cellular radio interface for example.

The computer system 800 includes a processor 810, which can be a conventional microprocessor such as an Intel pentium microprocessor or Motorola power PC microprocessor, a Texas Instruments digital signal processor, or some combination of the two types or processors. Memory 840 is coupled to the processor 810 by a bus 870. Memory 840 can be dynamic random access memory (dram) and can also include static ram (sram), or may include FLASH EEPROM, too. The bus 870 couples the processor 810 to the memory 840, also to non-volatile storage 850, to display controller 830, and to the input/output (I/O) controller 860. Note that the display controller 830 and I/O controller 860 may be integrated together, and the display may also provide input.

The display controller 830 controls in the conventional manner a display on a display device 835 which typically is a liquid crystal display (LCD) or similar flat-panel, small form factor display. The input/output devices 855 can include a keyboard, or stylus and touch-screen, and may sometimes be extended to include disk drives, printers, a scanner, and other input and output devices, including a mouse or other pointing device. The display controller 830 and the I/O controller 860 can be implemented with conventional well known technology. A digital image input device 865 can be a digital camera which is coupled to an I/O controller 860 in order to allow images from the digital camera to be input into the device 800.

The non-volatile storage 850 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 800. Rather, a mass storage device on another computer is typically used in conjunction with the more limited storage of the device 800. Some of this data is often written, by a direct memory access process, into memory 840 during execution of software in the device 800. One of skill in the art will immediately recognize that the terms “machine-readable medium” or “computer-readable medium” includes any type of storage device that is accessible by the processor 810 and also encompasses a carrier wave that encodes a data signal.

The device 800 is one example of many possible devices which have different architectures. For example, devices based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

In addition, the device 800 is controlled by operating system software which includes a file management system, such as a disk operating system, which is part of the operating system software. One example of an operating system software with its associated file management system software is the family of operating systems known as Windows CE® and Windows® from Microsoft Corporation of Redmond, Wash., and their associated file management systems. Another example of an operating system software with its associated file management system software is the Palm® operating system and its associated file management system. The file management system is typically stored in the non-volatile storage 850 and causes the processor 810 to execute the various acts required by the operating system to input and output data and to store data in memory, including storing files on the non-volatile storage 850. Other operating systems may be provided by makers of devices, and those operating systems typically will have device-specific features which are not part of similar operating systems on similar devices. Similarly, WinCE® or Palm® operating systems may be adapted to specific devices for specific device capabilities.

Device 800 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

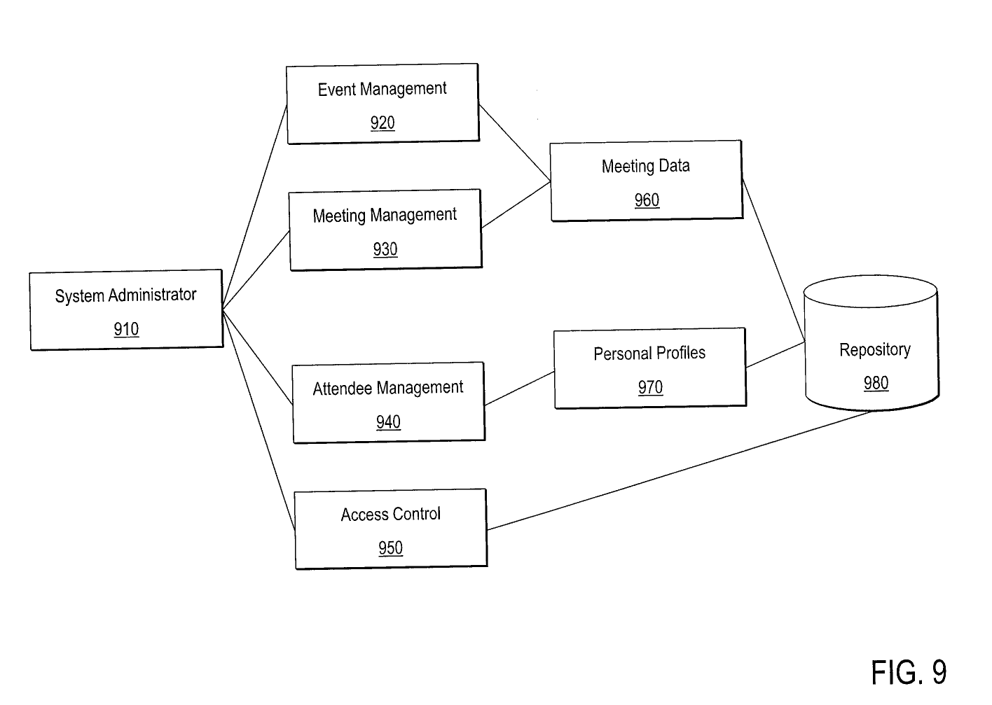

FIG. 9 illustrates transactions and interaction which may occur for a system administrator within the system in one embodiment. System 900 allows for a system administrator 910 to access event management 920, meeting management 930, attendee management 940 and access control management 950 functions of the system. Access control 950 changes access information for the repository (database) 980. Event management 920 and meeting management 930 functions change meeting data 960, which is part of an object (or objects or tables) in repository 980. The meeting data 960 may be conference or event information for the overall event, for example. Attendee management 940 function changes personal profiles 970, which may also be objects or data in repository 980. Personal profiles 970 may be tied to a meeting or event, or may be separate, persisting through various events, for example.

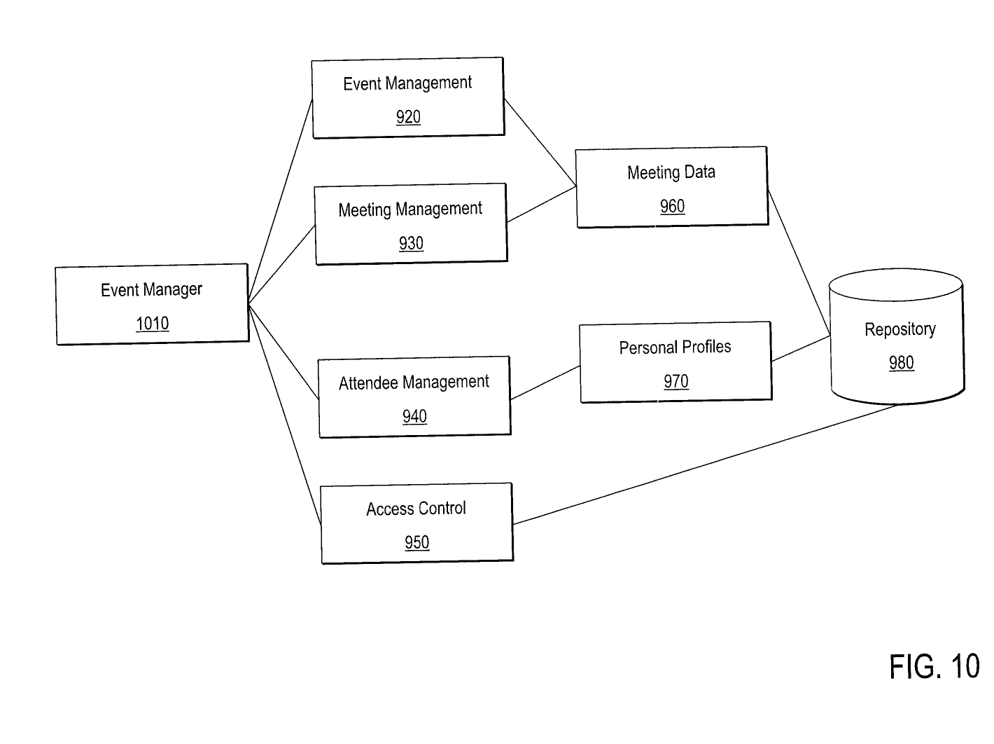

FIG. 10 illustrates transactions and interaction which may occur for an event manager within the system in one embodiment. An event manager 1010 may have capabilities similar to a system administrator 910, in terms of having overall access. However, an event manager 1010 may have restricted access in some areas, such as an ability to change events as part of a convention in meeting data 960, but not delete events or not change the overall meeting, for example. Similarly, event manager may have limited access to personal profiles 970, such as access only to information specific to the event in question. Moreover, access control 950 may be limited to access control for parts of the event, for example. Alternatively, event manager 1010 may have even more restricted access, much more akin to other users, for example.

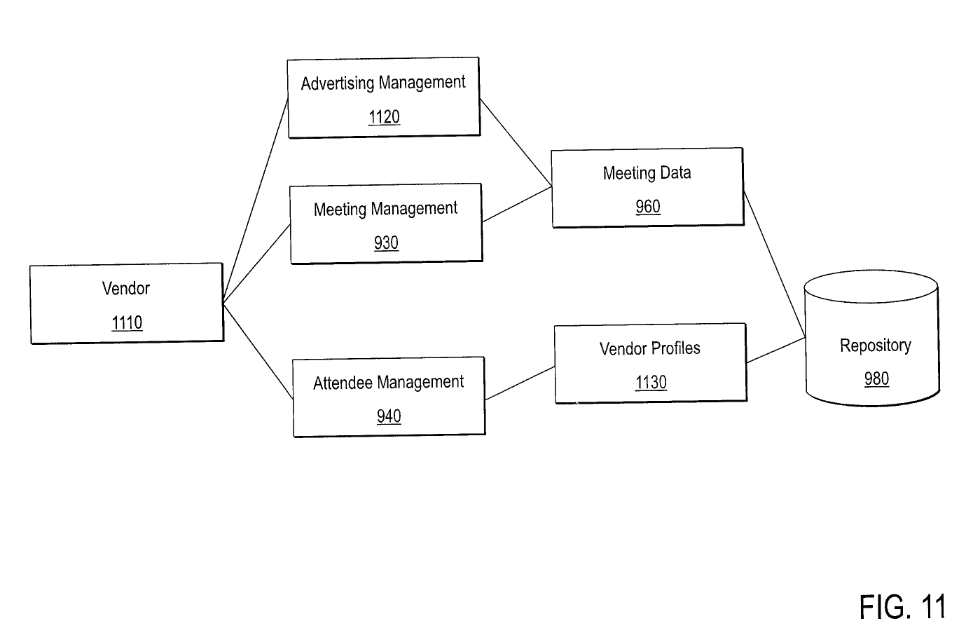

FIG. 11 illustrates transactions and interaction which may occur for a vendor within the system in one embodiment. Vendor 1110 may manage advertising (advertising management 1120) for the vendor 1110 in question. Similarly, vendor 1110 may manage personal meeting schedules for the vendor 1110, or manage meetings sponsored by the vendor 1110 through meeting management 930. Additionally, vendor 1110 may manage attendees through attendee management 940. This may affect the vendor profile 1130—adding or deleting attendees or providing or denying access to attendees for vendor information or meetings, rather than the actual user profiles, for example. As with other data, the vendor profile 1130 may be stored in repository 980.

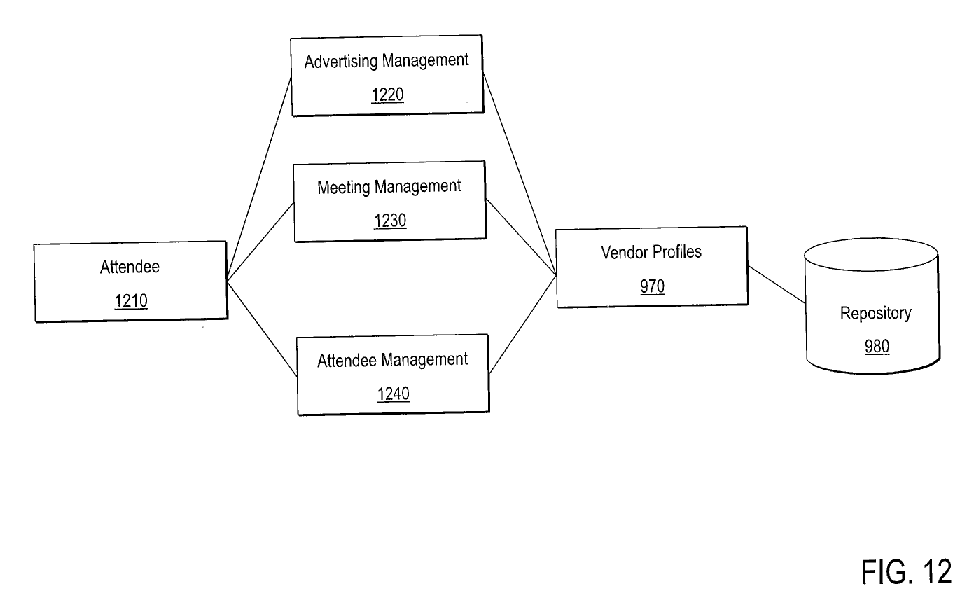

FIG. 12 illustrates transactions and interaction which may occur for a patron or attendee within the system in one embodiment. Attendee 1210 may manage events (1220), manage meetings (1230) or manage his own data (1240), all of which manage the attendee's personal profile 970 within repository 980. This may reflect into other profiles and meeting data, in terms of an attendee adding or deleting meetings, but such changes are based on the data personally accessible by attendee 1210.

One skilled in the art will appreciate that although specific examples and embodiments of the system and methods have been described for purposes of illustration, various modifications can be made without deviating from the present invention. For example, embodiments of the present invention may be applied to many different types of databases, systems and application programs. Moreover, features of one embodiment may be incorporated into other embodiments, even where those features are not described together in a single embodiment within the present document.

What is claimed is:

1. A method, comprising:
receiving a login identification from a user over the Internet;
encrypting a portion of the login identification from the user;
querying a database as to whether the login identification with the encrypted portion of the login identification matches an entry in the database, the database related to a convention which the user is attending;
and
granting the user access to the database.

2. The method of claim 1, further comprising:
receiving a request from the user for access to schedule information for the conference;
and
presenting schedule information to the user based on access control information associated with the login identification of the user.

3. The method of claim 2, further comprising:
receiving a request from the user for access to attendee information of other attendees for the conference;
and
presenting attendee information of other attendees to the user based on access control information associated with the login identification of the user.

4. The method of claim 3, wherein:
attendee information includes name, title, affiliation and contact information for attendees of the conference.

5. The method of claim 4, wherein:
attendee information for a given attendee may be withheld from other attendees responsive to preferences of the given attendee.

6. The method of claim 3, wherein:
attendee information of other attendees of the conference is presented to the user based on presence of the attendee information of other attendees of the conference in a designated subset of attendees of the conference responsive to access control permissions of the user.

7. The method of claim 2, wherein:
schedule information includes information about meetings of the convention, including time, location, and availability to the user.

8. The method of claim 2, wherein:
scheduling information includes information about personal meetings of the user with other attendees of the convention, including time and location.

9. The method of claim 1, further comprising:
presenting a map of the convention to the user.

10. The method of claim 9, further comprising:
receiving a selection from the user of a clickable portion of the map;
accessing information associated with the clickable portion of the map in the database;
and
presenting information associated with the clickable portion of the map related to the convention from the database.

11. The method of claim 1, wherein:
the user is a system administrator;
and further comprising:
receiving edits to information of the database from the user;
and
updating information in the database responsive to the edits to information of the database from the user.

12. The method of claim 1, wherein:
the method is embodied in a set of instructions embodied in a machine-readable medium, the set of instructions, when executed by a processor, causing the processor to implement the method.

13. The method of claim 1, further comprising:
receiving a request from the user for access to attendee information of other attendees for the conference;
presenting attendee information of other attendees to the user based on access control information associated with the login identification of the user;
receiving a request from the user for access to attendee information of other attendees for the conference;
presenting attendee information of other attendees to the user based on access control information associated with the login identification of the user;
presenting a map of the convention to the user;
receiving a selection from the user of a clickable portion of the map;
accessing information associated with the clickable portion of the map in the database;
and
presenting information associated with the clickable portion of the map related to the convention from the database.

14. A system, comprising:
a personal digital assistant (PDA) having a network interface;
the PDA having a user interface;
wherein the PDA is to:
receive login information from a user,
transmit the login information over the Internet to a server,
receive convention information from the server over the Internet consistent with access permissions of the user.

15. The system of claim 14, wherein:
the PDA includes means for communication of voice signals from the user with a cellular network.

16. The system of claim 14, wherein:
the PDA having a cellular network interface,
and
the user interface including a microphone and speaker.

17. The system of claim 14, wherein:
the PDA is to:
present a convention map in graphical form to the user.

18. A system, comprising:
a server computer,
the server computer including a network interface, the network interface coupled to the Internet;
the server computer including a database interface, the database interface to couple to a database having information related to a convention;
wherein:
the server computer has a first access path through the network interface for read and write access by privileged users through the server computer to the database and information related to the convention,
and
the server computer has a second access path through the network interface for read-only access by non-privileged users through the server computer to the database and information related to the convention.

19. The system of claim 18, wherein:
the server computer is implemented as a plurality of physical server computers,
wherein:
a first server computer of the plurality of physical server computers to accept and respond to data transactions along the first access path, including to encrypt a password from a user received through the first access path;
and
a second server computer of the plurality of physical server computers to accept and respond to data transactions along the second access path, including to encrypt a password from a user received through the second access path.

20. The system of claim 18, wherein:
the server computer is implemented as a single physical server computer,
wherein:
the single server computer is to accept and respond to data transactions along the first access path;
and
the single server computer is to accept and respond to data transactions along the second access path.
